(19) United States
(12) Patent Application Publication
(10) Pub. No.: US 2011/0026468 A1
(43) Pub. Date: Feb. 3, 2011

(54) MULTI-NETWORK TELEPHONE CONNECTIONS

(76) Inventors: Daniel R. Conrad, San Francisco, CA (US); Richard A. Miner, Cambridge, MA (US); Craig E. Walker, Diablo, CA (US); Lawrence Alder, Mountain View, CA (US); Minneola Ingersoll, San Francisco, CA (US); Douglas P. Garland, Palo Alto, CA (US); Joseph S. Faber, Lafayette, CA (US); Michael A. Pearson, San Francisco, CA (US)

Correspondence Address: FISH & RICHARDSON P.C., PO BOX 1022, MINNEAPOLIS, MN, 55440-1022, US

(21) Appl. No.: 12/510,879

(22) Filed: Jul. 28, 2009

(51) Int. Cl. H04W 40/00

(52) U.S. Cl. 370/329; 455/445; 370/352

(57) ABSTRACT

The subject matter of this specification can be implemented in, among other things, a computer-implemented method for centralized routing of voice communication over multiple communication networks including receiving at an electronic call routing system an incoming call from a calling device to a first telephone number of a mobile device. The method further includes selecting a calling address of the mobile device from among a voice over internet protocol address of the mobile device on an internet protocol network and a cellular telephone number of the mobile device on a cellular telephone network. The first telephone number is different than the cellular telephone number and the selection of the calling address is performed substantially without participation by the cellular telephone network. The method further includes connecting the incoming call to the selected calling address of the mobile device.

### TECHNICAL FIELD

This instant specification relates to routing telephone calls to mobile devices over multiple communications networks.

### BACKGROUND

Within recent memory, mobile telephones have evolved from a rare curiosity into a widely-available, indispensable business tool and social necessity. Mobile telephone users have come to rely on the ability to move about freely while carrying on a conversation with a remote party. This movement may be relatively slow as in the case of walking, or relatively fast as in the case of a traveling vehicle. In some instances, this movement may take the user out of the range of a particular transceiver, so that a “hand off” occurs and the user then communicates via a different transceiver (e.g., in a cellular telephone tower). In other instances, the movement may take the user entirely out of the cellular telephone network that provides the connection to the user's mobile telephone.

In some cases, the user may be within a theoretical range of the cellular telephone network, but the user may be in a dead-zone where the mobile telephone cannot access the cellular telephone network. For example, the mobile telephone may not have access to the cellular telephone network when the mobile telephone is deep within a building or blocked by a geographical feature, such as a hill or mountain. This can create a situation in which the user is not able to receive calls over the cellular telephone network. In addition, the user may not realize a call was missed until after the user reenters the range of the cellular telephone network or exits the dead-zone.

In addition, time spent using the cellular telephone network typically has an associated cost. Some mobile telephone users may subscribe to a pay-per-minute plan. For example, a user may purchase a particular number of minutes and then use those purchased minutes when making a call with the associated mobile telephone. Some mobile telephone users may have a fixed number of “free” minutes that are included in a monthly payment amount. Other rules may also apply, such as free minutes during certain days of the week or times of day, free minutes to members of the same cellular telephone network provider, or free minutes to a certain number of friends or family members. These costs associated with mobile telephone use can affect the mobile telephone user's decisions regarding whether to make a call and how long a call lasts. Typically, these costs are incurred even when receiving a call on the mobile telephone.

### SUMMARY

In general, this document describes routing a telephone call to or from a mobile device over multiple communications networks. In general, a mobile telephone device may be assigned two contact numbers. The first number can be used to home the device to a network of a cellular telephone carrier. The first number may not be seen by the user, but can be used as a gateway to the mobile virtual network operator (MVNO) for the carrier. The second number is the “public” number for the device and can be a universal access number like that provided by a service such as GRANDCENTRAL (now GOOGLE VOICE). Incoming calls can be routed by the service to any network that is currently available to the device, and a VoIP client on the device can keep the service notified regarding networks that are available to the device, and the service can use that information to determine which route, of multiple options, to use in sending calls to the device. The device can send outgoing calls directly to the service using any network that is available to the device for routing by the service, which can push the ring sound to the outgoing caller and dial the outgoing number, so that the call will sound like a normal call to the calling party. If a call is dropped, the service can maintain the connection to the other party to the call, and verbally notify that party that the service is attempting to reconnect the call.

In a first aspect, a computer-implemented method for centralized routing of voice communication over multiple communication networks includes receiving at an electronic call routing system an incoming call from a calling device to a first telephone number of a mobile device. The electronic call routing system is in communication with an internet protocol network and a cellular telephone network. The method further includes in response to receiving the incoming call to the first telephone number of the mobile device, selecting a calling address of the mobile device from among a voice over internet protocol address of the mobile device on the internet protocol network and a cellular telephone number of the mobile device on the cellular telephone network. The first telephone number is different than the cellular telephone number and the selection of the calling address is performed substantially without participation by the cellular telephone network. The method further includes connecting the incoming call to the selected calling address of the mobile device.

Implementations can include any, all, or none of the following features. The method can include determining a connection status of the mobile device on the internet protocol network, and wherein selecting the calling address can include selecting the voice over internet protocol address upon determining the connection status indicates that the mobile device is connected to the internet protocol network and selecting the cellular telephone number upon determining the connection status indicates the mobile device is not connected to the internet protocol network. The method can include monitoring the connection between the calling device and the mobile device, and maintaining the connection with the calling device upon the mobile device dropping the connection. The method can include reconnecting the incoming call to the calling address of the mobile device that was not selected. The method can include sending a message to a user of the calling device indicating that the incoming call to the mobile device can be being reconnected. The method can include monitoring the connection between the calling device and the mobile device, and, upon a signal strength of the connection with the mobile device going below a threshold signal strength level, concurrently connecting the incoming call to the mobile device using the calling address of the mobile device that was not selected. The method can include receiving from the mobile device updates to the voice over internet protocol address of the mobile device. Selecting the calling address of the mobile device can include selecting the calling address of a connection that has a lowest cost. Selecting the calling address of the connection that has the lowest cost can include analyzing billing rules associated with a connection using the cellular telephone number. The voice over internet protocol address of the mobile device can include the first telephone number.

In a second aspect, a computer-implemented system for centralized routing of voice communication over multiple communication networks includes a first interface in communication with a public switched telephone network connected to a cellular telephone network. The system further includes a second interface in communication with an internet protocol network. The system further includes a computerized call router that receives an incoming call from a calling device to a first telephone number of a mobile device, selects a calling address of the mobile device from among a voice over internet protocol address of the mobile device on the internet protocol network and a cellular telephone number of the mobile device on the cellular telephone network. The first telephone number is different than the cellular telephone number and the selection of the calling address is performed substantially without participation by the cellular telephone network. The computerized call router connects the incoming call to the selected calling address of the mobile device over the first interface if the cellular telephone number is selected or the second interface if the voice over internet protocol address is selected.

Implementations can include any, all, or none of the following features. The computerized call router can receive the incoming call through the second interface in communication with the internet protocol network. The system can include a call monitor that maintains the connection with the calling device if the mobile device drops the connection and reconnects the incoming call to the calling address of the mobile device that was not selected. The system can include a mobile device status updater that receives one or more status updates for corresponding connections to the mobile device, and the call router can select the calling address of the mobile device based on the received status updates.

In a third aspect, a computer-implemented system for centralized routing of voice communication over multiple communication networks includes a first interface in communication with a public switched telephone network connected to a cellular telephone network. The system further includes a second interface in communication with an internet protocol network. The system further includes means for selecting a calling address of the mobile device from among a voice over internet protocol address of the mobile device on the internet protocol network and a cellular telephone number of the mobile device on the cellular telephone network by which to connect an incoming call to the mobile device. The first telephone number is different than the cellular telephone number and the selection of the calling address is performed substantially without participation by the cellular telephone network.

The systems and techniques described here may provide one or more of the following advantages in certain implementations. First, a system can provide for reducing the cost of making calls using a mobile device. Second, a system can provide for reducing the number of calls that are dropped by a mobile device. Third, a system can provide for reducing the number of calls that are redialed due to a call that was dropped by a mobile device. Fourth, a system can provide for routing a telephone call to a single mobile device telephone number over multiple communication networks. Fifth, a system can provide for routing a call to a single mobile device telephone number over an existing internet protocol communication network or an existing cellular telephone communication network. Sixth, a system can provide for improving the fidelity of calls by routing over high-speed networks capable of higher fidelity. Seventh, a system can provide for integration of additional communication functionality into traditional calls (e.g., video calling, chat, etc).

The details of one or more implementations are set forth in the accompanying drawings and the description below. Other features and advantages will be apparent from the description and drawings, and from the claims.

### DESCRIPTION OF DRAWINGS

FIG. 1 is a schematic diagram showing an example of a system for routing a telephone call to or from a mobile device.

FIG. 2 is a block diagram showing an example of a system for routing a telephone call to or from a mobile device.

FIG. 3 is a flow chart showing an example of a process for routing a telephone call to a mobile device

FIG. 4 is a flow chart showing an example of a process for reconnecting a telephone call to a mobile device.

FIG. 5 shows an example of a computing device and a mobile computing device that can be used in connection with computer-implemented methods and systems described in this document.

Like reference symbols in the various drawings indicate like elements.

### DETAILED DESCRIPTION

This document describes systems and techniques for routing calls to or from a mobile device over multiple communication networks. For example, an incoming telephone call to a mobile device can be routed through a Voice over Internet Protocol (VoIP) communication network if the mobile device is currently connected to an Internet Protocol (IP) network or a cellular telephone network if the mobile device is currently connected to the cellular telephone network. In some implementations, a central system can maintain the connection with the caller if the mobile device becomes disconnected and another connection can be made to the mobile device. In some implementations, a dialer application at the mobile device handles routing of outgoing calls from the mobile device to another mobile device, landline telephone, or a VoIP application.

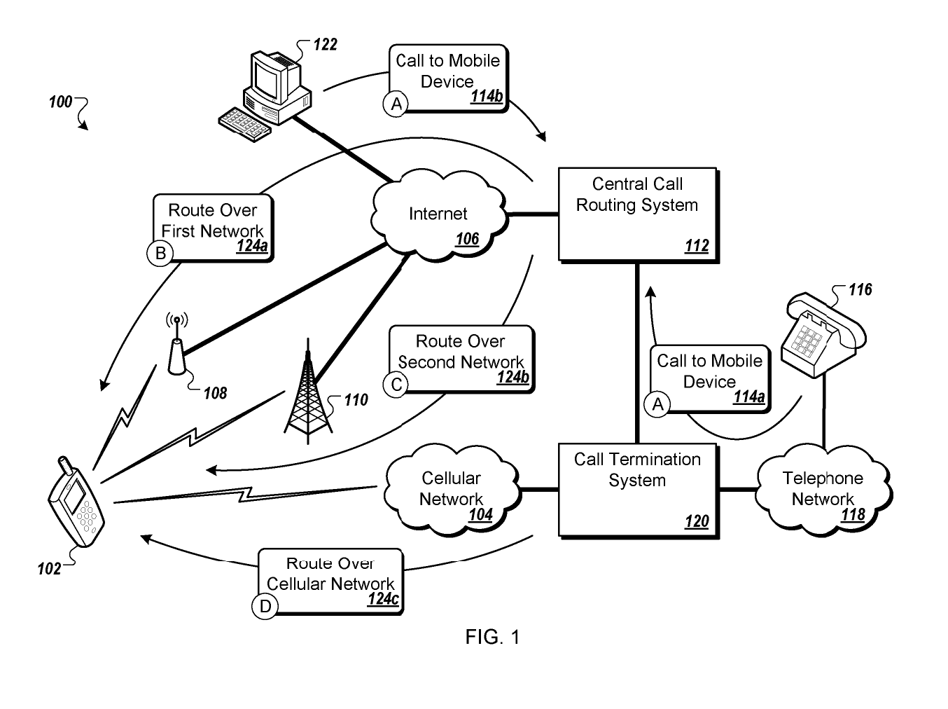

FIG. 1 is a schematic diagram showing an example of a system 100 for routing a telephone call to or from a mobile device 102. The mobile device 102 is a device capable of receiving or initiating telephone calls over multiple wireless connection types. For example, the mobile device 102 can receive or initiate telephone calls over a cellular telephone network 104 and a network such as the Internet 106 that is capable of supporting VoIP calls.

In some implementations, the cellular telephone network 104 uses a code division multiple access (CDMA) protocol (e.g., CDMA2000), a time division multiple access (TDMA) protocol (e.g., GSM), or another cellular telephone communication protocol. The mobile device 102 may also be capable of communicating over multiple different such networks. The mobile device 102 can connect to the Internet 106 through multiple wireless network interfaces in certain implementations, such as a wireless local area network 108 (e.g., a Wi-Fi network) and a wireless wide area network 110 (e.g., a WiMAX network).

The system 100 includes a central call routing system 112. The central call routing system 112 can receive one or more incoming calls 114a-b to the mobile device 102. For example, the central call routing system 112 can receive the incoming call 114a from a telephone device 116. The central call routing system 112 receives the incoming call 114a over a telephone network 118, such as a public switched telephone network (PSTN). The system 100 can further include a call termination system 120. The call termination system 120 provides connectivity between the telephone network 118, the cellular telephone network 104, and the central call routing system 112. In some implementations, the central call routing system 112 can also receive the incoming call 114b to the mobile device 102 from a computer device 122. In some implementations, the central call routing system 112 can receive the incoming call 114b over the Internet 106.

The central call routing system 112 may perform a number of different functions with respect to communication services provided to a user of the mobile device 102. For example, the central call routing system 112 may permit a user to define call routing rules to various communication devices that the user employs. For example, the central call routing system 112 can assign a single incoming telephone number to the user, and may forward incoming calls in real-time to whatever device the user is currently in possession of. As one simple example, the user can define rules so that incoming calls are routed to the user's work telephone during business hours and the user's home telephone outside of business hours. Also, the central call routing system 112 can perform call screening (e.g., by identifying incoming calls as corresponding to telephone numbers of people with whom the user does not wish to speak) and other such telecommunication management functions.

The central call routing system 112 may also select a connection mechanism, from among multiple connection mechanisms available on a device, for connecting with the device. For example, with respect to the incoming calls shown here, the central call routing system 112 selects either the wireless local area network 108, the wireless wide area network 110, or the cellular telephone network 104 for routing the incoming calls 114a-b to the mobile device 102. In some implementations, the central call routing system 112 selects one of multiple routes 124a-c based on a cost of connections made over the routes 124a-c. For example, the route 124a may be a free connection, the route 124b may have a small cost, and the route 124c may have a highest cost of the routes 124a-c. The central call routing system 112 therefore selects the route 124a first, the route 124b second, and the route 124c last.

In some implementations, the central call routing system 112 analyzes billing rules associated with the routes 124a-c to determine which of the routes 124a-c has the lowest cost. For example, the route 124c over the cellular telephone network 104 may have a number of free minutes allowed each month for calls to or from the mobile device 102. The central call routing system 112 may select the route 124c before the route 124a until the number of free minutes in the month have been used and thereafter selects the routes 124a-b.

The cost of a route may also be based on other factors, such as the device or telephone number of the device making the call to the mobile device 102. For example, if the telephone device 116 is in the same cellular carrier network (in-network), is identified as a favorite or frequently called telephone number, or is identified as a family member of the mobile device 102 (e.g., for a friends and family plan), then calls between the telephone device 116 and the mobile device 102 over the cellular telephone network 104 may be free. The central call routing system 112 can analyze the in-network, favorites, and family rules to determine if the route 124c over the cellular telephone network 104 is free, and if so, it can connect the telephone device 116 to the mobile device 102 through the cellular telephone network 104.

In some implementations, the central call routing system 112 selects the routes 124a-c based on a status of the connection over the routes 124a-c. For example, the mobile device 102 may report the connectivity status of the routes 124a-c to the central call routing system 112. In some implementations, the mobile device 102 may report a status of a connection periodically. The central call routing system 112 uses the status of the routes 124a-c to select a route for the incoming calls 114a-b.

For example, the route 124a may be preferred due to a lowest cost, but the current status of the route 124a may indicate that the mobile device 102 is not currently in communication with the wireless local area network 108. If the status of the route 124b indicates that the mobile device 102 is in communication with the wireless wide area network 110, then the central call routing system 112 selects the route 124b and connects the incoming call to the mobile device 102 over the wireless wide area network 110.

The availability of a particular route for taking a call can be determined in a number of different ways. In some implementations, the central call routing system 112 determines that the mobile device 102 is not in communication over a particular route, such as the route 124a, by comparing the time the last update of the status of the route 124a was received to the current time. If the two times differ by more than a threshold amount, then the mobile device 102 is identified as not being in communication over the wireless local area network 108. Alternatively or in addition, another rule may be used, such as a particular number of missed status updates, where under normal operation the status is updated periodically.

In some implementations, the central call routing system 112 selects one of the routes 124a-b based on a connection or call quality. For example, VoIP-to-VoIP calls may have a higher call quality than a VoIP call that is converted for transmission over the cellular telephone network 104 and then presented at the mobile device 102. Consequently, if the central call routing system 112 receives the incoming call 114b from the computer device 122 over the Internet 106, then the central call routing system 112 may prefer the routes 124a-b rather than the route 124c. The central call routing system 112 can create a direct VoIP-to-VoIP call without going through the call termination system 120, the telephone network 118, or the cellular telephone network 104. For example, for calling devices that use VoIP dialers that are compatible with the VoIP dialer used by the mobile device 102, the central call routing system 112 can create a direct connection over the Internet 106 between the calling device and the mobile device 102.

In some implementations, where the central call routing system 112 selects one of the routes 124a-b over the Internet 106, the central call routing system 112 initiates the connection to the mobile device 102. For example, after receiving the incoming call 114a from the telephone device 116, the central call routing system 112 selects the route 124a and opens a connection to the mobile device 102 over the wireless local area network 108. In some implementations, the status of the routes 124a-b over the Internet 106 may include a network address of the mobile device 102. The central call routing system 112 may use the network address of the mobile device 102 to open the connection to the mobile device 102 over the wireless local area network 108.

Alternatively, the central call routing system 112 may select the route 124a and place the incoming call 114a in a queue at the central call routing system 112. The mobile device 102 may periodically check the queue at the central call routing system 112 to determine if any calls are waiting. The mobile device 102 determines that the incoming call 114a is waiting and opens a connection to the telephone device 116 through the wireless local area network 108 and the central call routing system 112. In some implementations, if the mobile device 102 does not read the incoming call 114a from the queue within a threshold amount of time, the central call routing system 112 removes the incoming call 114a from the queue and forwards the incoming call 114a to the mobile device 102 over the cellular telephone network 104.

In some implementations, when placing a telephone call to the mobile device 102, a calling device, such as the telephone device 116, dials a first telephone number of the mobile device 102 that is directed to the central call routing system 112. For example, the telephone network 118 may direct the incoming call 114a to the call termination system 120. The call termination system 120 then directs the incoming call 114a to the central call routing system 112. The central call routing system 112 then selects a route to the mobile device 102 over the Internet 106 or over the cellular telephone network 104.

The central call routing system 112 can connect the incoming call 114a through the route 124c over the cellular telephone network 104 by forwarding the call to a second telephone number. The cellular telephone carrier that operates the cellular telephone network 104 uses the second telephone number to direct calls to the mobile device 102 over the cellular telephone network 104. For example, the central call routing system 112 redirects the call placed by the telephone device 116 to the second telephone number. The call termination system 120 processes the redirected call from the central call routing system 112. The call termination system 120 sends the redirected call to the telephone network 118 and/or the cellular telephone network 104. The cellular telephone network 104 passes the redirected call to the mobile device 102 which has been assigned the second telephone number.

In some implementations, the user of the mobile device 102 can configure the cellular telephone number to be used by the mobile device 102 on the cellular telephone network 104. For example, the dialer application operating at the mobile device 102 can provide a user interface for inputting a cellular telephone number. In another example, the central call routing system 112 can provide a user interface, such as a web page interface, for inputting a cellular telephone number for the mobile device 102. In some implementations, a cellular telephone number associated with the mobile device 102 can be determined by the central call routing system 112, such as by recording the cellular telephone number upon issuing the mobile device 102 to a user or by setting the cellular telephone number of the mobile device 102.

In some implementations, the routing of calls to the mobile device 102 by the central call routing system 112 does not require configuration of the cellular telephone number by the user of the mobile device 102. For example, the cellular telephone number of the mobile device 102 may be stored at the central call routing system 112 prior to providing the mobile device 102 to the user.

In general, the selection of a route to the mobile device 102 by the central call routing system 112 does not substantially include participation by the cellular telephone network 104, other than to send a redirected call to the second (cellular) telephone number of the mobile device 102. For example, the central call routing system 112 does not rely on the cellular telephone network 104, or other system provided by the cellular carrier, to select the route to the mobile device 102. The central call routing system 112 does not require special purpose hardware or services from the cellular telephone network 102 in order to perform the route selection. The central call routing system 112 does not require integration with the cellular telephone network 102, such as in the case of Unlicensed Mobile Access (UMA), in order to perform the route selection. The central call routing system 112 does require a connection with the cellular telephone network 104, or another network that provides connectivity to the cellular telephone network 104, in order to forward telephone calls to the cellular telephone number of the mobile device 102 when the central call routing system 112 selects the route over the cellular telephone network 104.

In some implementations, the central call routing system 112 may be collocated and/or connected directly to the cellular telephone network 104. Alternatively, the central call routing system 112 may connect to the cellular telephone network 104 through the telephone network 118. In some implementations, the central call routing system 112 may also connect to the cellular telephone network 104 through the Internet 106. Accordingly, the connection between the call termination system 120 and the cellular telephone network 104 may be through either the telephone network 118 or the Internet 106.

In some implementations, the system 100 can include multiple cellular networks. Accordingly, the central call routing system 112 can route calls over the multiple cellular networks. For example, the central call routing system 112 can choose a cellular network to connect to based on call quality or billing rules. In some implementations, the mobile device 102 can have multiple cellular telephone numbers. For example, the mobile device 102 can have a Subscriber Identity Module (SIM) card for a first cellular network and another SIM card for a second cellular network. In some implementations, the cellular telephone numbers of the mobile device 102 are only associated with a single device. In some implementations, the telephone number for the mobile device 102 that is first directed to the central call routing system 112 may be routed to multiple devices, either one at a time or concurrently.

In some implementations, the call to the mobile device 102 is a voice call. Alternatively, the call may be a Short Message Service (SMS), Enhanced Messaging Service (EMS), or Multimedia Messaging Service (MMS) call. For example, the central call routing system 112 can receive a request to send an SMS, EMS, or MMS message to a telephone number of the mobile device 102. The central call routing system 112 can then forward the message on to a telephone number of the mobile device 102 on the cellular telephone network 104. Alternatively, the central call routing system 112 can route the message through the Internet 106 to an application operating at the mobile device 102, such as the dialer application or an instant message application. As previously described with respect to voice calls, the selection of a route though either the cellular telephone network 104 or the Internet 106 can be based on, for example, the status of the connection between the mobile device 102 on those networks and the cost of sending the message over those networks.

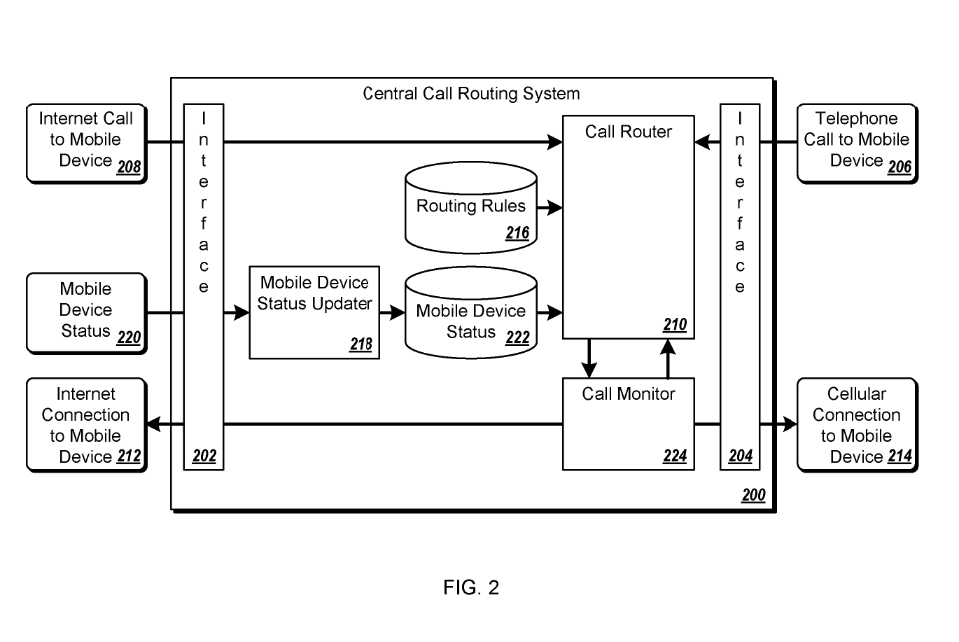

FIG. 2 is a block diagram showing an example of a central call routing system 200 for routing a telephone call to or from a mobile device. The central call routing system 200 includes an interface 202 and an interface 204. The interface 202 provides communication with an IP network. The interface 204 provides communication with a public switched telephone network including a cellular telephone network. The central call routing system 200 can receive an incoming call 206 through the interface 204 or an incoming call 208 through the interface 202.

The central call routing system 200 also includes a call router 210. The call router 210 receives the incoming call 206 and/or the incoming call 208. The call router 210 selects a connection 212 through the interface 202 and the IP network or a connection 214 through the interface 204 and the cellular telephone network. The call router 210 can use one or more routing rules 216 in performing the selection of a connection. For example, the connection 212 and the connection 214 may have associated costs and the call router 210 may select from the available connections, a connection with the lowest cost.

The routing rules 216 can be stored at the central call routing system 200 or another location accessible by the call router 210. The routing rules 216 may be predefined by administrators of the central call routing system 200. In some implementations, the user of the mobile device may specify one or more of the routing rules 216, such as through a web page interface. For example, the central call routing system 200 can provide a web page to the user through the interface 202 that allows the user to access and modify the routing rules 216 to be applied to the user's mobile device.

The central call routing system 200 includes a mobile device status updater 218. The mobile device status updater 218 receives one or more status updates 220 from the mobile device. The mobile device may periodically send updates to the mobile device status updater 218 to inform the central call routing system 200 that one or more IP network connections are active. In some implementations, the mobile device sends the status updates 220 through the IP network that is active. Alternatively, the mobile device can send the status updates 220 as single message through one IP network, where the single message describes each of the IP network connections that are currently active.

The mobile device status updater 218 stores the status updates 220 in a data storage 222. In some implementations, the mobile device status updater 218 stores the IP network addresses of the active connections to the mobile device. In some implementations, the status updates 220 specify the IP network addresses. In some implementations, an IP network address can be derived from the metadata of the status updates 220, e.g., the network address of the device during the connection when a status update is received. In some implementations, this derived network address can be compared to a network address specified in the status updates 220 to verify that the specified network address is correct or alert a user that a discrepancy exists.

In some implementations, the mobile device status updater 218 can send a request for a status update to the mobile device. For example, the mobile device status updater 218 can retrieve a last known network address of the mobile device from the data storage 222 and send the status update request to that address. In some implementations, the mobile device status updater 218 sends a request for an updated status to the mobile device when the mobile device status updater 218 has not received an update to a particular connection status within a threshold amount of time. In some implementations, the mobile device status updater 218 identifies the connection to the mobile device as inactive if the mobile device does not provide a reply to the update request within a threshold amount of time. Accordingly, the mobile device status updater 218 stores the inactive connection status in the data storage 222.

In general, an IP network using a protocol such as Dynamic Host Configuration Protocol (DHCP) may reassign a previous network address of the mobile device to some other mobile device. Accordingly, the mobile device provides an identifier in the status update that uniquely identifies the mobile device or otherwise authenticates the response from the mobile device to the mobile device status updater 218.

In one example, the status updates 220 include a VOIP dialer user name and password. A VOIP dialer user name can be, for example, free-form text, an email address, or a telephone number. In some implementations, the VOIP dialer user name is the address by which other devices initiate calls to the mobile device through the IP network.

In another example, the status updates 220 include a pre-shared key. The mobile device status updater 218 may provide the pre-shared key to the mobile device. In some implementations, the authentication may include a key that changes over time or rotates through a series of keys as subsequent status updates are sent.

The call router 210 uses the status information in the data storage 222 and the routing rules 216 to select a destination connection for the incoming call 206 or the incoming call 208. For example, where the routing rules 216 specify that VoIP-to-VoIP call quality is a priority, the call router 210 can connect the incoming call 208 from the interface 202 through the connection 212. In another example, the call router 210 may determine from the data storage 222 that the IP network connections to the mobile device are inactive. The call router 210 then forwards or redirects the incoming call 208 to the connection 214 through the interface 204. In some implementations, the call router 210 forwarding the incoming call 208 through the connection 214 includes forwarding the incoming call that was originally directed to a first telephone number to a second telephone that is registered to the mobile device on the cellular network.

In some implementations, when the call router 210 routes an incoming call through the IP network, the call router 210 directly opens a connection to the mobile device through the VoIP interface. Alternatively, the call router 210 can place the incoming call on a queue for the mobile device at the central call routing system 200. A dialer application at the mobile device then periodically checks the queue at the central call routing system 200 to determine if any calls to the mobile device are pending. The checking of the queue can include authentication of the mobile device and/or the central call routing system 200, such as previously described. If the mobile device finds a pending incoming call in the queue, then the mobile device can take appropriate action, such as alerting the user with an audible ring, a flashing light, and/or a vibration. In some implementations, the mobile device automatically answers the call, such as in a push-to-talk or walkie-talkie scenario.

In some implementations, the mobile device and the central call routing system 200 maintain an open connection, such that the VoIP connection between the mobile device and the central call routing system 200 has already been made prior to receiving the incoming call. The call router may then immediately inform the mobile device of the incoming call.

In some implementations, maintaining the status and/or maintaining an open connection reduces the latency between the time that the central call routing system 200 receives an incoming call and the time the mobile device is connected to the incoming call. For example, if the central call routing system 200 has already identified a VoIP connection as inactive, then the central call routing system 200 does not need to spend time polling the VoIP connection to determine the status of the connection at the time the incoming call is received.

If the status of a connection changes during a call, such as when the mobile device goes outside the range of the network being used for the call, then the central call routing system 200 maintains the connection to the calling party and attempts to reconnect the call through another network. The central call routing system 200 includes a call monitor 224 that monitors the connection to the mobile device during a call. If the call monitor 224 determines that the connection to the mobile device has been dropped, then the call monitor 224 informs the calling party that the call monitor 224 is attempting to reconnect the calling party to the mobile device. The call monitor 224 uses the connection status information in the data storage 222 to determine if any other connections are available. If so, the call monitor 224 attempts to reconnect the call through the identified alternative connection.

The mobile device can, in certain circumstances, report a connection strength to the call monitor 224 or the call monitor 224 can determine a connection strength or quality between the central call routing system 200 and the mobile device. If the connection strength and/or quality falls below a threshold level, then the call monitor 224 can initiate a second connection through another active network concurrently with the initial call. The call monitor 224 and the dialer application at the mobile device can then gradually transfer the call from the initial connection to the second connection if the connection strength and/or quality does not improve.

For example, a mobile device may be connected with another caller using a VoIP connection through a WiFi network. The user subsequently walks out of the range of the WiFi connection. The mobile device and the central call routing system 200 then detect the weakness of the signal and preemptively initiate a connection on the cellular network. The central call routing system 200 and the mobile device switch the call seamlessly to the new cellular connection and terminate the WiFi connection. In another example, the central call routing system 200 and the mobile device can switch from a cellular network to a WiFi network while a call is in progress, such as when the user returns home and enters the range of a WiFi network. In another example, the central call routing system 200 and the mobile device can switch from one cellular carrier connection to another based on billing rules.

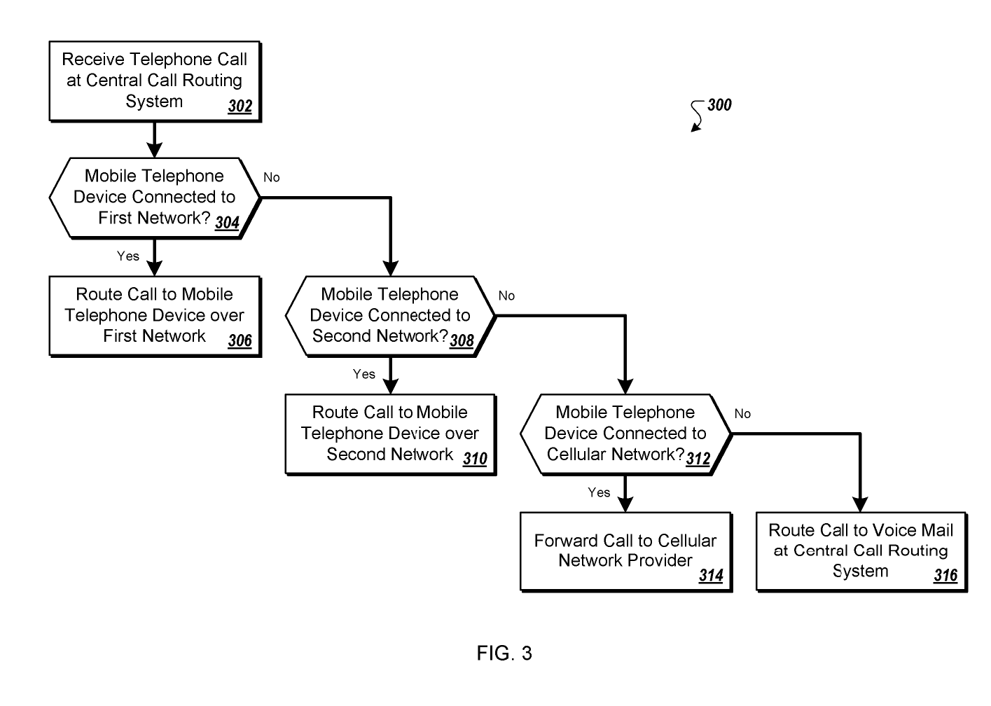

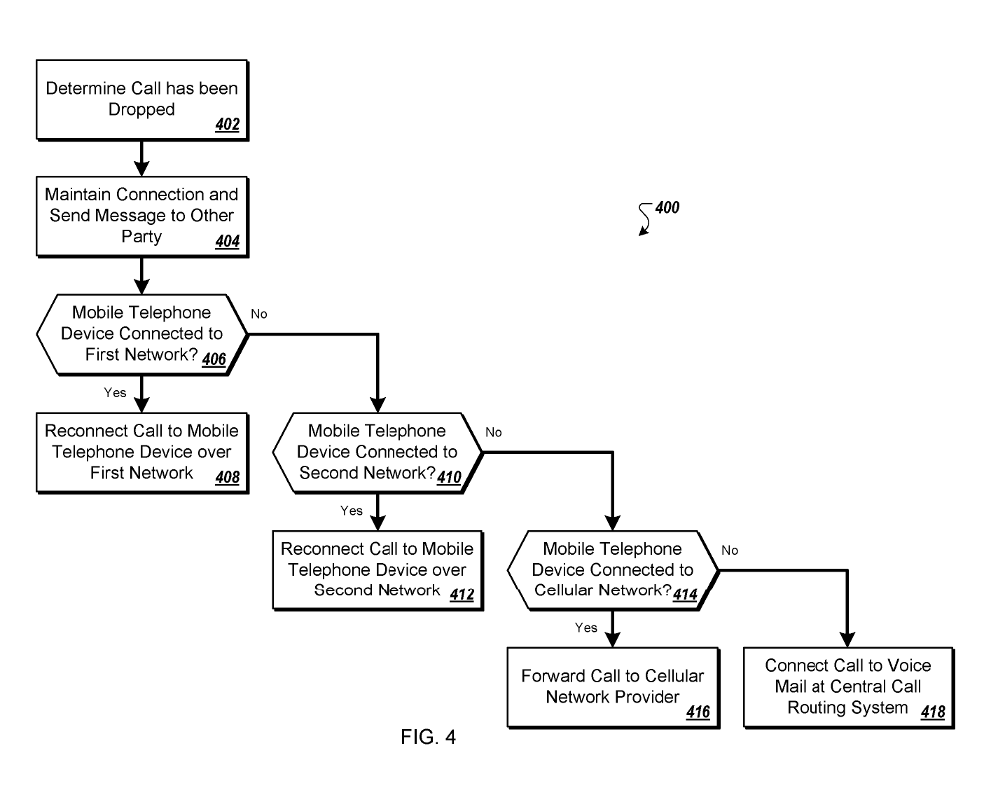

FIGS. 3 and 4 are flow charts showing examples of processes for routing and reconnecting a telephone call to a mobile device. The processes may be performed, for example, by a system such as the system 100 and the central call routing system 200. For clarity of presentation, the description that follows uses the system 100 and the central call routing system 200 as the basis of examples for describing the processes. However, another system, or combination of systems, may be used to perform the processes.

FIG. 3 is a flow chart showing an example of a process 300 for routing a telephone call to a mobile device. The process 300 begins with receiving (302) an incoming call from a calling device to a first telephone number of a mobile device. For example, the central call routing system 112 can receive the incoming calls 114a-b from the telephone device 116 and the computer device 122 to the first telephone number of the mobile device 102. The first telephone number of the mobile device 102 first directs the incoming calls 114a-b to the central call routing system 112.

The process 300 selects a calling address of the mobile device from among at least a voice over internet protocol address of the mobile device on an internet protocol network and a cellular telephone number of the mobile device on a cellular telephone network. The process 300 connects the incoming call to the selected calling address of the mobile device.

For example, if the connection between the mobile device 102 and the wireless local area network 108 is active (304), then the central call routing system 112 routes (306) the incoming call through the wireless local area network 108. Otherwise, if the connection between the mobile device 102 and the wireless wide area network 110 is active (308), then the central call routing system 112 routes (310) the incoming call through the wireless wide area network 110. Otherwise, if the connection between the mobile device 102 and the cellular telephone network 104 is active (312), then the central call routing system 112 forwards (314) the incoming call to a cellular telephone number of the mobile device 102 on the cellular telephone network 104. Finally, if no connections to the mobile device 102 are active, then the central call routing system 112 connects (316) the incoming call to a voice mail inbox associated with the first telephone number.

While the routing described with respect to FIG. 3 is based on the status of the connections to the mobile device, the routing can also be based on other rules, such as the costs of the connections. For example, the order in which the connections are checked in FIG. 3 may be determined by the cost of each connection, with the most inexpensive being checked for an active connection first and the most expensive being last.

FIG. 4 is a flow chart showing an example of a process 400 for reconnecting a telephone call to a mobile device. The process 400 begins with monitoring (402) the connection between the calling device and the mobile device. For example, the call monitor 224 can monitor the initial call connection to the mobile device 102.

The process 400 maintains (404) the connection with the calling device upon the mobile device dropping the connection and sends a message to the calling device indicating that the incoming call to the mobile device is being reconnected. For example, the call monitor 224 can maintain the connection to the telephone device 116 and send a message to the telephone device 116 indicating that the call to the mobile device 102 is being reconnected.

The process 400 reconnects the incoming call to the calling address of the mobile device that was not selected. For example, if the connection between the mobile device 102 and the wireless local area network 108 is active (406), then the call monitor 224 routes (408) the incoming call through the wireless local area network 108. Otherwise, if the connection between the mobile device 102 and the wireless wide area network 110 is active (410), then the call monitor 224 routes (412) the incoming call through the wireless wide area network 110. Otherwise, if the connection between the mobile device 102 and the cellular telephone network 104 is active (414), then the call monitor 224 forwards (416) the incoming call to a cellular telephone number of the mobile device 102 on the cellular telephone network 104. Finally, if no connections to the mobile device 102 are active, then the call monitor 224 connects (418) the incoming call to a voice mail inbox associated with the first telephone number.

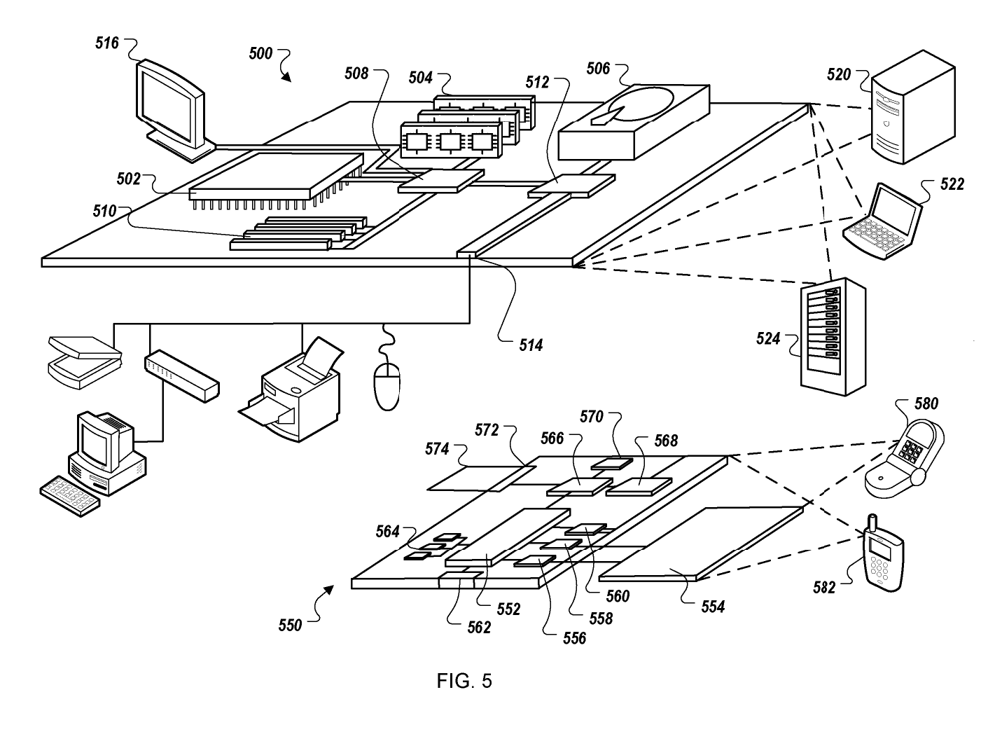

FIG. 5 shows an example of a computing device 500 and a mobile computing device that can be used to implement the techniques described here. The computing device 500 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 500 includes a processor 502, a memory 504, a storage device 506, a high-speed interface 508 connecting to the memory 504 and multiple high-speed expansion ports 510, and a low-speed interface 512 connecting to a low-speed expansion port 514 and the storage device 506. Each of the processor 502, the memory 504, the storage device 506, the high-speed interface 508, the high-speed expansion ports 510, and the low-speed interface 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as a display 516 coupled to the high-speed interface 508. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 504 stores information within the computing device 500. In some implementations, the memory 504 is a volatile memory unit or units. In some implementations, the memory 504 is a non-volatile memory unit or units. The memory 504 may also be another form of computer-readable medium, such as a magnetic or optical disk.

The storage device 506 is capable of providing mass storage for the computing device 500. In some implementations, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The computer program product can also be tangibly embodied in a computer- or machine-readable medium, such as the memory 504, the storage device 506, or memory on the processor 502.

The high-speed interface 508 manages bandwidth-intensive operations for the computing device 500, while the low-speed interface 512 manages lower bandwidth-intensive operations. Such allocation of functions is exemplary only. In some implementations, the high-speed interface 508 is coupled to the memory 504, the display 516 (e.g., through a graphics processor or accelerator), and to the high-speed expansion ports 510, which may accept various expansion cards (not shown). In the implementation, the low-speed interface 512 is coupled to the storage device 506 and the low-speed expansion port 514. The low-speed expansion port 514, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. In addition, it may be implemented in a personal computer such as a laptop computer 522. It may also be implemented as part of a rack server system 524. Alternatively, components from the computing device 500 may be combined with other components in a mobile device (not shown), such as a mobile computing device 550. Each of such devices may contain one or more of the computing device 500 and the mobile computing device 550, and an entire system may be made up of multiple computing devices communicating with each other.

The mobile computing device 550 includes a processor 552, a memory 564, an input/output device such as a display 554, a communication interface 566, and a transceiver 568, among other components. The mobile computing device 550 may also be provided with a storage device, such as a micro-drive or other device, to provide additional storage. Each of the processor 552, the memory 564, the display 554, the communication interface 566, and the transceiver 568, are interconnected using various buses, and several of the components may be mounted on a common motherboard or in other manners as appropriate.

The processor 552 can execute instructions within the mobile computing device 550, including instructions stored in the memory 564. The processor 552 may be implemented as a chipset of chips that include separate and multiple analog and digital processors. The processor 552 may provide, for example, for coordination of the other components of the mobile computing device 550, such as control of user interfaces, applications run by the mobile computing device 550, and wireless communication by the mobile computing device 550.

The processor 552 may communicate with a user through a control interface 558 and a display interface 556 coupled to the display 554. The display 554 may be, for example, a TFT (Thin-Film-Transistor Liquid Crystal Display) display or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may provide communication with the processor 552, so as to enable near area communication of the mobile computing device 550 with other devices. The external interface 562 may provide, for example, for wired communication in some implementations, or for wireless communication in other implementations, and multiple interfaces may also be used.

The memory 564 stores information within the mobile computing device 550. The memory 564 can be implemented as one or more of a computer-readable medium or media, a volatile memory unit or units, or a non-volatile memory unit or units. An expansion memory 574 may also be provided and connected to the mobile computing device 550 through an expansion interface 572, which may include, for example, a SIMM (Single In Line Memory Module) card interface. The expansion memory 574 may provide extra storage space for the mobile computing device 550, or may also store applications or other information for the mobile computing device 550. Specifically, the expansion memory 574 may include instructions to carry out or supplement the processes described above, and may include secure information also. Thus, for example, the expansion memory 574 may be provide as a security module for the mobile computing device 550, and may be programmed with instructions that permit secure use of the mobile computing device 550. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer- or machine-readable medium, such as the memory 564, the expansion memory 574, or memory on the processor 552. In some implementations, the computer program product can be received in a propagated signal, for example, over the transceiver 568 or the external interface 562.

The mobile computing device 550 may communicate wirelessly through the communication interface 566, which may include digital signal processing circuitry where necessary. The communication interface 566 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 568 using a radio-frequency. In addition, short-range communication may occur, such as using a Bluetooth, WiFi, or other such transceiver (not shown). In addition, a GPS (Global Positioning System) receiver module 570 may provide additional navigation- and location-related wireless data to the mobile computing device 550, which may be used as appropriate by applications running on the mobile computing device 550.

The mobile computing device 550 may also communicate audibly using an audio codec 560, which may receive spoken information from a user and convert it to usable digital information. The audio codec 560 may likewise generate audible sound for a user, such as through a speaker, e.g., in a handset of the mobile computing device 550. Such sound may include sound from voice telephone calls, may include recorded sound (e.g., voice messages, music files, etc.) and may also include sound generated by applications operating on the mobile computing device 550.

The mobile computing device 550 may be implemented in a number of different forms, as shown in the figure. For example, it may be implemented as a cellular telephone 580. It may also be implemented as part of a smart-phone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A computer-implemented method for centralized routing of voice communication over multiple communication networks, comprising:
receiving at an electronic call routing system an incoming call from a calling device to a first telephone number of a mobile device, wherein the electronic call routing system is in communication with an internet protocol network and a cellular telephone network;
in response to receiving the incoming call to the first telephone number of the mobile device, selecting a calling address of the mobile device from among a voice over internet protocol address of the mobile device on the internet protocol network and a cellular telephone number of the mobile device on the cellular telephone network, wherein the first telephone number is different than the cellular telephone number and the selection of the calling address is performed substantially without participation by the cellular telephone network; and
connecting the incoming call to the selected calling address of the mobile device.

2. The method of claim 1, further comprising determining a connection status of the mobile device on the internet protocol network, and wherein selecting the calling address comprises selecting the voice over internet protocol address upon determining the connection status indicates that the mobile device is connected to the internet protocol network and selecting the cellular telephone number upon determining the connection status indicates the mobile device is not connected to the internet protocol network.

3. The method of claim 1, further comprising monitoring the connection between the calling device and the mobile device, and maintaining the connection with the calling device upon the mobile device dropping the connection.

4. The method of claim 3, further comprising reconnecting the incoming call to the calling address of the mobile device that was not selected.

5. The method of claim 4, further comprising sending a message to a user of the calling device indicating that the incoming call to the mobile device is being reconnected.

6. The method of claim 1, further comprising monitoring the connection between the calling device and the mobile device, and, upon a signal strength of the connection with the mobile device going below a threshold signal strength level, concurrently connecting the incoming call to the mobile device using the calling address of the mobile device that was not selected.

7. The method of claim 1, further comprising receiving from the mobile device updates to the voice over internet protocol address of the mobile device.

8. The method of claim 1, wherein selecting the calling address of the mobile device includes selecting the calling address of a connection that has a lowest cost.

9. The method of claim 8, wherein selecting the calling address of the connection that has the lowest cost includes analyzing billing rules associated with a connection using the cellular telephone number.

10. The method of claim 1, wherein the voice over internet protocol address of the mobile device includes the first telephone number.

11. A computer-implemented system for centralized routing of voice communication over multiple communication networks, comprising:
a first interface in communication with a public switched telephone network connected to a cellular telephone network;
a second interface in communication with an internet protocol network; and
a computerized call router that receives an incoming call from a calling device to a first telephone number of a mobile device, selects a calling address of the mobile device from among a voice over internet protocol address of the mobile device on the internet protocol network and a cellular telephone number of the mobile device on the cellular telephone network, wherein the first telephone number is different than the cellular telephone number and the selection of the calling address is performed substantially without participation by the cellular telephone network, and connects the incoming call to the selected calling address of the mobile device over the first interface if the cellular telephone number is selected or the second interface if the voice over internet protocol address is selected.

12. The system of claim 11, wherein the computerized call router receives the incoming call through the second interface in communication with the internet protocol network.

13. The system of claim 11, further comprising a call monitor that maintains the connection with the calling device if the mobile device drops the connection and reconnects the incoming call to the calling address of the mobile device that was not selected.

14. The system of claim 11, further comprising a mobile device status updater that receives one or more status updates for corresponding connections to the mobile device, and wherein the call router selects the calling address of the mobile device based on the received status updates.

15. A computer-implemented system for centralized routing of voice communication over multiple communication networks, comprising:
a first interface in communication with a public switched telephone network connected to a cellular telephone network;
a second interface in communication with an internet protocol network; and
means for selecting a calling address of the mobile device from among a voice over internet protocol address of the mobile device on the internet protocol network and a cellular telephone number of the mobile device on the cellular telephone network, wherein the first telephone number is different than the cellular telephone number and the selection of the calling address is performed substantially without participation by the cellular telephone network by which to connect an incoming call to the mobile device.
